(19) United States
(12) Patent Application Publication
(10) Pub. No.: US 2017/0291619 A1
(43) Pub. Date: Oct. 12, 2017

(54) Mechanized Signal Mast

(71) Applicant: Progress Rail Services Corporation, Albertville, AL (US)

(72) Inventors: Donald King, Louisville, KY (US); Thomas Tougas, Lee's Summit, MO (US)

(73) Assignee: Progress Rail Services Corporation, Albertville, AL (US)

(21) Appl. No.: 15/092,932

(22) Filed: Apr. 7, 2016

(51) Int. Cl. B61L 5/18; B61L 7/06; B61L 9/04; G08G 1/095

(52) U.S. Cl. CPC B61L 5/189; G08G 1/095; B61L 7/06; B61L 9/04; B61L 2207/02; B61L 2207/00

(57) ABSTRACT

A signal structure is disclosed. The signal structure may include a housing and a light head disposed within the housing. The light head may include at least one signal light mounted thereto. The signal structure may also include at least one actuator operatively coupled to the light head and configured to move the light head within the housing.

### FIELD OF THE DISCLOSURE

The present disclosure relates generally to signal systems and, more particularly, to railroad wayside signal light structures.

### BACKGROUND OF THE DISCLOSURE

Railroad wayside signal systems are used to control the speed and position of a locomotive on a railroad track relative to highway crossings and other locomotives on the track. Typically, these systems consist of a mast that is mounted to a support base positioned adjacent to the railroad track. A light head is fixedly mounted to the mast, and one or more signal lights are fixedly mounted on the light head. An engineer of the locomotive sees the signal lights and controls the speed and position of the locomotive accordingly.

For the signal lights to be in view of locomotive engineers, the light head is mounted on the mast at a vertical height that is above or proximate to a height of the locomotive. In order to check, adjust, or maintain the signal lights, maintenance personnel have to climb a ladder to a platform that is adjacent to the signal lights. Accordingly, there is a need for a railroad wayside signal system that does not require maintenance personnel to climb up to the signal lights.

A railroad wayside signal system is disclosed in U.S. Pat. No. 7,561,066, entitled, “Railroad Wayside Signal System.” The '066 railroad wayside signal system includes a mast that is attached to a support structure in an upright position. In the '066 patent, a signal head having one or more signal lights is mounted to the mast. The '066 mast pivots with respect to the support structure between the upright position and a substantially horizontal position for maintaining and/or aligning the signal head and signal lights.

While arguably effective, there is still a need for an improved railroad wayside signal system that moves the signal head and the signal lights without having to move the mast, or pivot an entire height of the mast into a horizontal position.

### SUMMARY OF THE DISCLOSURE

In accordance with one embodiment, a signal structure is disclosed. The signal structure may include a housing and a light head disposed within the housing. The light head may include at least one signal light mounted thereto. The signal structure may also include at least one actuator operatively coupled to the light head and configured to move the light head within the housing.

In accordance with another embodiment, a signal structure is disclosed. The signal structure may include a light head, a signal light mounted to the light head, a stationary housing enclosing the light head and the signal light, at least one electric actuator operatively coupled to the light head and configured to move the light head within the stationary housing, and a controller in operative communication with the at least one electric actuator. The controller may be configured to move the light head within the stationary housing according to input received from an operator.

In accordance with another embodiment, a method for moving a light head within a stationary housing of a signal structure is disclosed. The light head may be operatively coupled to an actuator. The actuator may include a motor in communication with a controller. The method may include receiving an input signal to move the light head within the stationary housing, and sending a signal to the motor to drive the actuator based on the input signal. The receiving and sending may be performed by the controller. The method may further include moving the light head within the stationary housing, the moving being performed by the actuator.

### BRIEF DESCRIPTION OF THE DRAWINGS

FIG. 1 is a perspective view of a signal structure, in accordance with one embodiment of the present disclosure;

FIG. 2 is a perspective view of a side of the signal structure of FIG. 1;

FIG. 3 is a schematic representation of the signal structure of FIG. 1, in accordance with another embodiment;

FIG. 4 is a diagrammatic view of the signal structure of FIG. 1, in accordance with another embodiment;

FIG. 5 is a schematic representation of a signal structure, in accordance with another embodiment; and

FIG. 6 is a flowchart illustrating a process for moving a light head within a stationary housing of a signal structure, in accordance with another embodiment.

While the present disclosure is susceptible to various modifications and alternative constructions, certain illustrative embodiments thereof will be shown and described below in detail. The disclosure is not limited to the specific embodiments disclosed, but instead includes all modifications, alternative constructions, and equivalents thereof.

### DETAILED DESCRIPTION

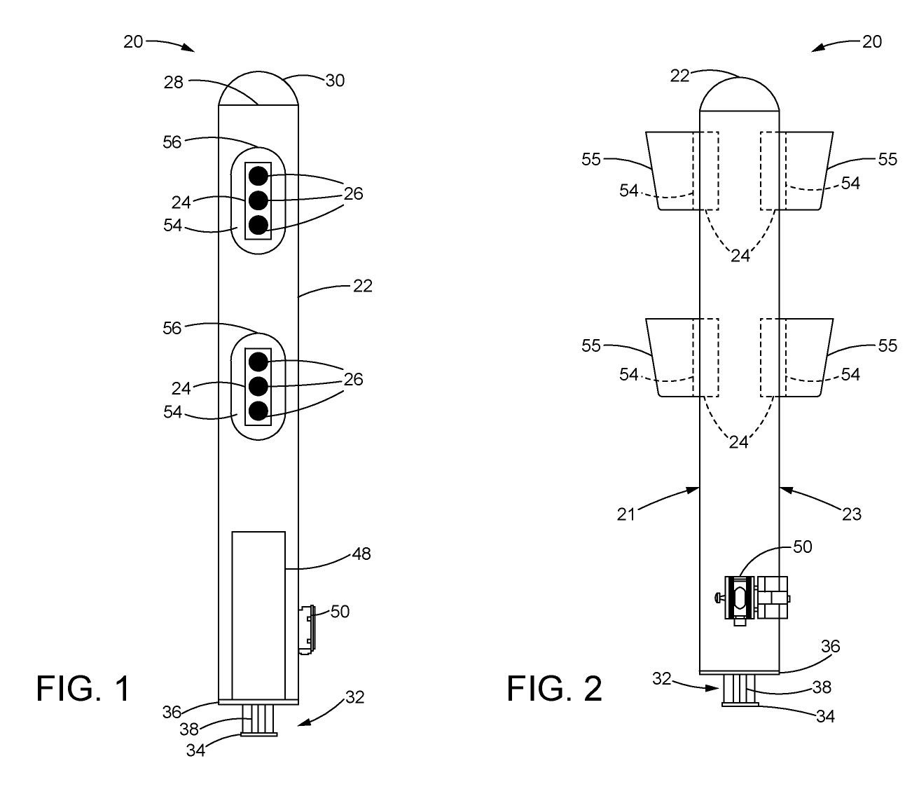

Referring now to the drawings, and with specific reference to FIGS. 1 and 2, a signal structure 20 is shown, in accordance with certain embodiments of the present disclosure. For example, the signal structure 20 may be disposed proximate a railroad track and utilized as a railroad wayside signal. However, other applications of the signal structure 20 are possible. It is to be understood that the signal structure 20 is shown primarily for illustrative purposes to assist in disclosing features of various embodiments, and that FIGS. 1 and 2 does not depict all of the components of a signal structure.

The signal structure 20 may include a housing 22 and at least one light head 24 disposed within the housing 22. For instance, two light heads 24 may be disposed on each of a first side 21 and a second side 23 of the signal structure 20, although other configurations may be used. Furthermore, although four light heads 24 are shown in the signal structure 20 of FIGS. 1 and 2, more or less than four light heads 24 may be positioned inside the housing 22.

Each light head 24 may include at least one aspect or signal light 26 mounted thereto. Three signal lights 26 are mounted to each light head 24 in FIGS. 1 and 2. However, more or less than three signal lights 26 may be mounted to each light head 24. In an example, each signal light 26 may comprise a light emitting diode (LED), although other types of light sources may be used.

The housing 22 may include an inner frame 28 wrapped in a protective layer 30. For example, the inner frame 28 may be composed of steel, such as galvanized steel, although other materials may be used. For instance, the inner frame 28 may comprise steel angles, a steel box, and the like. The protective layer 30 may protect components disposed within the housing 22 from moisture, weather conditions, and debris. Although the protective layer 30 may be composed of sheet metal, other materials may be used. Furthermore, the protective layer 30 may be bolted to the inner frame 28. However, other means of attachment may be used.

In addition, the housing 22 may be built upon a base 32. For example, the base 32 may include a base plate 34, a housing mounting plate 36, and a pipe 38 therebetween. The base plate 34 may serve as a foundation in the ground for the signal structure 20. The pipe 38 may elevate the housing 22 and serve as a conduit for electrical wiring to the light heads 24. Furthermore, the pipe 38 may include gussets or other strengthening and stiffening features. The housing 22 may extend vertically upward from the housing mounting plate 36. More specifically, the inner frame 28 may be directly coupled to the housing mounting plate 36. However, other configurations for the base 32 may be used.

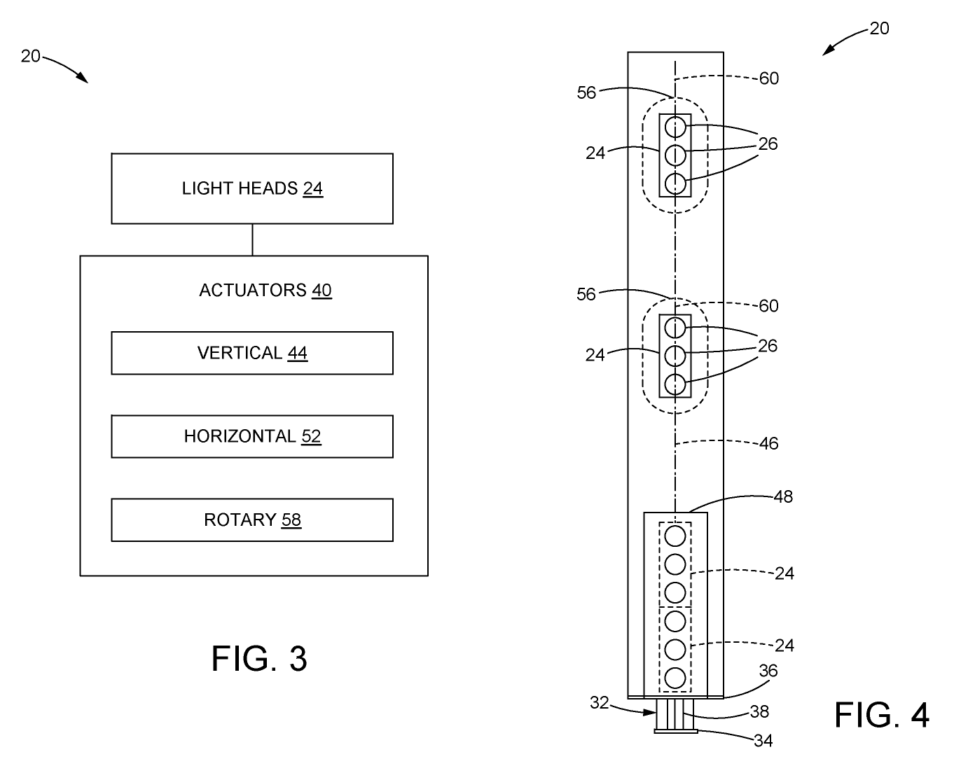

Turning now to FIG. 3, with continued reference to FIGS. 1 and 2, a schematic representation of the signal structure 20 is shown, in accordance with another embodiment. The signal structure 20 may further include at least one actuator 40 operatively coupled to each light head 24 and disposed within the housing 22. The actuators 40 may be configured to move the light heads 24 within the housing 22. The housing 22 may be stationary and may enclose the light heads 24, the signal lights 26, and the actuators 40, thereby protecting such components.

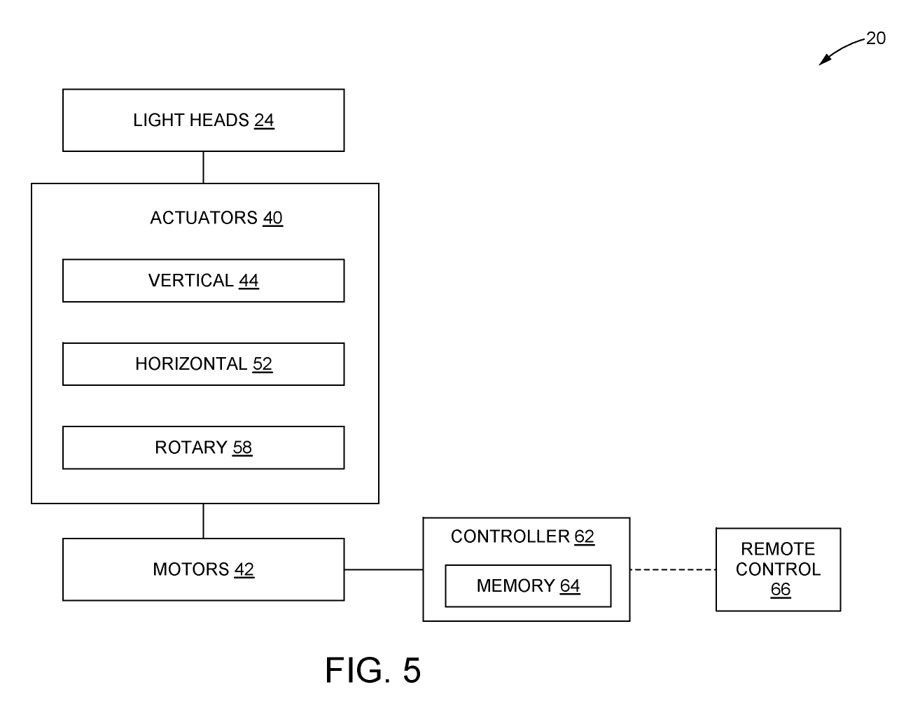

In one example, each light head 24 may be coupled to its own separate actuator 40, wherein such actuator is configured to move only one light head. In another example, more than one light head 24 may be coupled to the same actuator 40, wherein such actuator is configured to move more than one light head. For instance, a first actuator may be coupled to and configured to move light heads on the first side 21 of the signal structure 20, while a second actuator may be coupled to and configured to move light heads on the second side 23 of the signal structure 20. The at least one actuator 40 coupled to each light head 24 may include a first linear actuator 44 for vertical movement of each light head 24 within the housing 22. The first linear actuators 44 may be configured to move the light heads 24 in an upward direction and a downward direction inside the housing 22. The light heads 24 may be lowered and raised using the first linear actuators 44 such that they travel along a vertical path 46, as shown in FIG. 4. In so doing, maintenance personnel may check, adjust, and maintain the signal lights 26 without climbing a ladder.

For instance, each of the first side 21 and the second side 23 of the signal structure 20 may have an access door 48 in the housing 22 adjacent to the base 32 to access the light heads 24 and the signal lights 26. However, other configurations may be used. Once the light heads 24 are lowered, maintenance personnel may examine the light heads 24 and the signal lights 26 by opening the access door 48 on each side 21, 23.

In addition, electrical wiring to the light heads 24 may be routed through flexible conduits inside the housing 22 to accommodate movement of the light heads 24. Each of the flexible conduits may comprise a flexible hose, a flexible cable tray, and the like. The flexible conduits may extend from each of the light heads 24 to a power supply, such as a connection in a junction box 50 to the power grid.

The at least one actuator 40 coupled to each light head 24 may further include a second linear actuator 52 (FIG. 3) for horizontal movement of each light head 24 within the housing 22. The second linear actuators 52 may be configured to move the light heads 24 in a side-to-side direction, such as toward and away from the first side 21 and the second side 23 of the signal structure 20. In one example, the second linear actuators 52 may be used to move the light heads horizontally 24 such that they may be subsequently lowered to the access door 48 and brought back into position sealed against the housing 22, as shown in phantom in FIG. 2.

Moreover, a transparent shield 54 (FIG. 2) may surround each of the light heads 24. Each transparent shield 54 may cover and seal to an opening 56 in the housing 22. The openings 56 in the housing 22 provide for visibility of the signal lights 26. Each of the openings 56 may have an opaque shield 55 coupled thereto, the opaque shields 55 covering the openings 56 and transparent shields 54. The opaque shields 55 may be composed of sheet metal, or other materials, and may be configured to protect the visibility of the signal lights 26 from snow and other elements. The transparent shields 54 may provide protection to the light heads 24 while allowing display and visibility of the signal lights 26. For example, the transparent shields 54 may be composed of clear plastic, acrylic, polycarbonate, and other transparent materials.

In one example, the transparent shields 54 may be mounted to the light heads 24 such that they move with the light heads 24 within the housing 22. In this example, with the transparent shields 54 directly coupled to the light heads 24, the second linear actuators 52 may move the light heads 24 and transparent shields 54 horizontally inward, and the first linear actuators 44 may move the same vertically downward proximate the base 32 for maintenance. Continuing the example, after maintenance personnel have checked the light heads 24, the first linear actuators 44 may move the light heads 24 and transparent shields 54 vertically upward, and the second linear actuators 52 may move the same horizontally outward toward the openings 56 until the transparent shields 54 seal with the openings 56, such as with rubber seals lining the openings 56.

In another example, the transparent shields 54 may be mounted to the housing 22 instead of the light heads 24. For instance, each transparent shield 54 may be sealed to each opening 56 in the housing 22 and stay stationary with the housing 22 while the light heads 24 move inside the housing 22. In this example, with the transparent shields 54 directly coupled to the housing 22, the second linear actuators 52 may not be necessary. The first linear actuators 44 may move the light heads 24 downward for maintenance and upward into position for display, and a need for horizontal movement of the light heads 24 may be eliminated. However, other arrangements may be used for the actuators 40, the light heads 24, and the transparent shields 54.

Each of the first linear actuators 44 and the second linear actuators 52 may comprise a belt-driven actuator or a screw-driven actuator. For example, a bracket, or other connecting mechanism, may be attached to each light head 24, and a follower of each actuator 44, 52 may be attached to the bracket. A belt of the belt-driven actuator or a screw of the screw-driven actuator may then move the follower, and thereby the light head 24. However, other types of linear and nonlinear actuators for providing vertical and horizontal movement of the light heads 24 may be used.

In addition, the at least one actuator 40 coupled to each light head 24 may further include a rotary actuator 58 (FIG. 3) for rotation of the light head 24 within the housing 22. The rotary actuator 58 may be configured to rotate the light head 24, such as about a vertical axis 60 (FIG. 4) of the light head 24. Rotating the light head 24 about the vertical axis 60 may provide side-to-side angular movement of the light head 24. In so doing, the signal lights 26 may be adjusted to be visible to locomotive engineers, such as proximate a curved railroad.

The same or an additional rotary actuator 58 may be configured to rotate the light head 24 forward and backward. In so doing, the light head 24 may be tilted forward and backward for increased visibility of the signal lights 26. An angular range of motion for each light head 24 side-to-side and/or tilting forward and backward may be negative ten degrees to positive ten degrees (−10° to +10°). However, other angular ranges may be used.

Furthermore, the actuators 40 may be mechanical, electric, electro-mechanical, pneumatic, hydraulic, and of any other type. In an example wherein the actuators 40 are mechanical, maintenance personnel may operate the actuators 40 by hand, such as via a handwheel or any other mechanism positioned proximate the access doors 48. In this example, the actuators 40 may comprise a chain and sprocket system, a belt and pulley system, an ACME threaded rod system, and the like. However, mechanical and non-mechanical configurations may be used.

For instance, each light head 24 may include an attachment flange with an aperture. Another attachment flange with an aperture may be coupled to each of the actuators 40, such as, to a chain of the chain and sprocket system, a belt of the belt and pulley system, or a follower of the ACME threaded rod system. The apertures in the attachment flanges of the light head 24 and the actuator 40 may be aligned, and a pin may be inserted there through in order to couple the light head 24 to the actuator 40. However, other configurations for attaching the light heads 24 to the actuators 40 may be used.

Turning now to another example in FIG. 5, with continued reference to FIGS. 1-4, the actuators 40 may be electric, such as powered by one or more electric motors 42. In this example, a controller 62 may be in operative communication with the at least one actuator 40. The controller 62 may disposed within the junction box 50 or within the housing 22 proximate the access doors 48, although other positions for the controller 62 may be used. The controller 62 may comprise a programmable logic controller (PLC). However, the controller 62 may be implemented using any processor-based device that may include or be associated with a non-transitory computer readable storage medium having stored thereon computer-executable instructions, or any other suitable means for electronically controlling functionality of the at least one actuator 40.

For example, the controller 62 may be configured to operate according to predetermined algorithms or sets of instructions for operating the at least one actuator 40. Such algorithms or sets of instructions may be programmed or incorporated into a memory 64 associated with or at least accessible to the controller 62. The memory 64 may comprise a non-volatile memory provided within and/or external to the controller 62. It is understood that the controller 62 may include other hardware, software, firmware, and combinations thereof.

The controller 62 may be configured to control the actuators 40 and move the light heads 24 within the housing 22 according to input received from an operator. For instance, the controller 62 may include an operator interface having push buttons, joysticks, or other operator controls. The operator interface may be configured to send signals indicative of operator input to the controller 62. Based on the signals from the operator interface, the controller 62 may send signals to move the actuators 40, and thereby move the light heads 24.

For example, the push buttons of the operator interface may have arrows, or other indicators, to show the operator which button to press in order to move the light heads 24 in a certain direction. In addition, the controller 62 may have different modes for the push buttons and may switch between vertical movement, horizontal movement, and/or rotation of the light heads 24 using the same push buttons. However, other configurations for the operator controls and the operator interface may be used.

In addition, a remote control 66 may be in wireless communication with the controller 62. The remote control 66 may be configured to wirelessly operate the controller 62 from a distance. For instance, the remote control 66 may comprise a handheld electronic device that uses infrared, Bluetooth, radio, or other wireless technology to communicate operator input to the controller 62.

The remote control 66 may include operator controls, such as push buttons similar to the operator interface of the controller 62. However, other configurations for the operator controls on the remote control 66 may be used. The remote control 66 may be configured to wirelessly transmit signals indicative of operator input to the controller 62. Based on the signals from the remote control 66, the controller 62 may send signals to move the actuators 40, and thereby move the light heads 24.

With the remote control 66, maintenance personnel may operate the controller 62 and move the light heads 24 at a distance from the signal structure 20. Therefore, a one-person maintenance crew can adjust positions of the signal lights 26 while standing at a location or distance from the signal structure 20 that has an advantageous view of the signal lights 26. In so doing, it is not necessary to have more than one maintenance person examine the signal structure 20.

Moreover, the controller 62 may be in communication with the motors 42 that power the actuators 40. Based on signals indicative of operator input received from the operator interface of the controller 62 and/or the remote control 66, the controller 62 may be configured to send signals to the motors 42 to control movement of the light heads 24 within the housing 22. More specifically, the controller 62 may send electrical signals to the motors 42, which convert electrical power into mechanical power for the actuators 40 coupled to the light heads 24. Based on the operator input signals, the controller 62 may be configured to send signals to specific motors 42 in order to power specific actuators 40 and obtain a desired movement for the various light heads 24.

Based on the signals from the controller 62 and the speed of the motors 42, the motors 42 may drive the actuators 40 to move the light heads 24 a corresponding distance and/or an angular rotation. For example, the controller 62 may be configured to send signals to the motors 42 to power the actuators 40 for a duration of a time period the operator is pressing a push button on the controller 62 and/or the remote control 66. In so doing, the operator may manually control the distance and the angular rotation adjustments of the light heads 24 via the operator interface of the controller 62 and/or the remote control 66.

In another example, the controller 62 may be configured to move the light heads 24 a predetermined distance preprogrammed into the memory 64 of the controller 62. For instance, when the operator presses a push button on the controller 62 and/or the remote control 66 to move the light heads 24, the controller 62 may automatically move the light heads 24 a predetermined distance to a corresponding position associated with and indicated by the push button. In so doing, precise manipulation of operator controls by the operator to obtain proper positioning of the light heads 24 may be unnecessary.

More specifically, the controller 62 may send signals to the motors 42 to drive the actuators 40 for a predetermined time period. The predetermined time period may be preprogrammed into the memory 64 of the controller 62 and correspond to a predetermined distance. For example, if the operator presses a push button to move the light heads 24 down, the controller 62 may send signals to the motors 42 to power the actuators 40 for a predetermined time period that moves the light heads 24 a corresponding predetermined distance such that the light heads 24 automatically stop upon reaching the base 32 and/or the access door 48.

Continuing the example, if the operator presses a push button to move the light heads 24 up, the controller 62 may send signals to the motors 42 to power the actuators 40 for a predetermined time period that moves the lights heads 24 a corresponding predetermined distance such that the light heads 24 automatically stop upon reaching normal operating positions proximate the openings 56 of the housing 22. However, other configurations for automatically controlling movement of the light heads 24 may be used.

### INDUSTRIAL APPLICABILITY

In general, the foregoing disclosure finds utility in various industrial applications, such as in transportation systems. In particular, the disclosed signal structure may be applied to signal systems, such as to railroad wayside signal systems. The disclosed signal structure includes electric actuators to control the position of the signal lights. More specifically, the actuators transport the signal lights between their normal operating positions and ground level. In so doing, the need for maintenance personnel to climb a prior art railroad wayside signal mast-ladder-platform is eliminated.

Furthermore, the signal lights, actuators, motors, and controller are located inside the stationary housing of the signal structure, which provides protection of such components against moisture, weather conditions, and debris. In so doing, the interior components of the signal structure may have a decreased risk to rust and a longer life span. The disclose signal structure also includes rotary adjustment of the light heads, wireless remote control of the controller, transparent shields for the light heads, and flexible conduits for the light head wiring, all of which add to an innovative, robust, and efficient railroad wayside signal system.

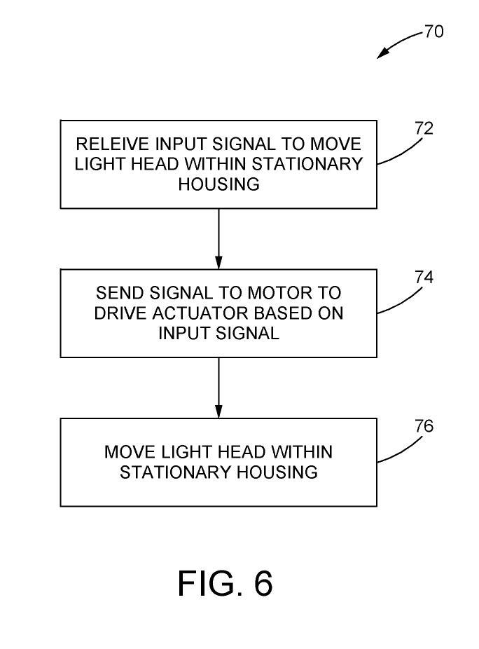

Turning now to FIG. 6, with continued reference to FIGS. 1-5, an example process 70 for moving the light head 24 within the stationary housing 22 of the signal structure 20 is shown, according to another embodiment of the present disclosure. At least part of the process 70 may be programmed into the memory 64 associated with the controller 62 of the signal structure 20. At block 72, the controller 62 may receive an input signal, such as via the operator interface of the controller 62, to move the light head 24 within the stationary housing 22.

At block 74, the controller 62 may send a signal to the motor 42 to drive the actuator 40 based on the input signal. At block 76, the actuator 40 may move the light head 24 within the stationary housing 22. For example, the actuator 40 may be coupled to the light head 24 and may be driven by the motor 42. When the motor 42 drives the actuator 40, the light head 24 may move for the time period indicated by the controller 62.

It is to be understood that the flowchart in FIG. 6 is shown and described as an example only to assist in disclosing the features of the disclosed signal structure, and that more or less steps than that shown may be included in the process corresponding to the various features described above for the disclosed signal structure without departing from the scope of the disclosure.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto. Moreover, while some features are described in conjunction with certain specific embodiments, these features are not limited to use with only the embodiment with which they are described, but instead may be used together with or separate from, other features disclosed in conjunction with alternate embodiments.

What is claimed is:

1. A signal structure, comprising:
a housing;
a light head disposed within the housing, the light head including at least one signal light mounted thereto; and
at least one actuator operatively coupled to the light head and configured to move the light head within the housing.

2. The signal structure of claim 1, further comprising a transparent shield sealed to an opening in the housing for display of the at least one signal light.

3. The signal structure of claim 1, further comprising a transparent shield mounted to the light head such that the transparent shield moves with the light head within the housing.

4. The signal structure of claim 1, wherein the housing includes sheet metal bolted to an inner frame composed of galvanized steel.

5. The signal structure of claim 1, wherein the at least one signal light comprises a light emitting diode.

6. The signal structure of claim 1, further comprising a flexible cable tray surrounding a wire connecting the at least one signal light to a power supply.

7. The signal structure of claim 1, wherein the at least one actuator comprises one of a belt-driven actuator and a screw-driven actuator.

8. The signal structure of claim 1, wherein the at least one actuator comprises one of a chain and sprocket system, a belt and pulley system, and an ACME threaded rod system.

9. The signal structure of claim 1, wherein the at least one actuator includes a first linear actuator for vertical movement of the light head within the housing.

10. The signal structure of claim 9, wherein the at least one actuator includes a second linear actuator for horizontal movement of the light head within the housing.

11. The signal structure of claim 10, wherein the at least one actuator includes a rotary actuator for rotation of the light head within the housing.

12. The signal structure of claim 11, wherein each of the first linear actuator, the second linear actuator, and the rotary actuator is powered by an electric motor and controlled by a controller.

13. A signal structure, comprising:
a light head;
a signal light mounted to the light head;
a stationary housing enclosing the light head and the signal light;
at least one electric actuator operatively coupled to the light head and configured to move the light head within the stationary housing; and
a controller in operative communication with the at least one electric actuator, the controller configured to move the light head within the stationary housing according to input received from an operator.

14. The signal structure of claim 13, wherein the controller comprises a programmable logic controller.

15. The signal structure of claim 13, further comprising a remote control in wireless communication with the controller, the remote control configured to wirelessly operate the controller at a distance from the signal structure.

16. The signal structure of claim 13, wherein the at least one electric actuator includes an electric motor in communication with the controller, the controller configured to send signals to the electric motor to control movement of the light head within the stationary housing.

17. The signal structure of claim 16, wherein the controller is configured to move the light head a predetermined distance preprogrammed into a memory of the controller.

18. A method for moving a light head within a stationary housing of a signal structure, the light head operatively coupled to an actuator including a motor in communication with a controller, the method comprising:
receiving an input signal to move the light head within the stationary housing;
sending a signal to the motor to drive the actuator based on the input signal, the receiving and sending being performed by the controller; and
moving the light head within the stationary housing, the moving being performed by the actuator.

19. The method of claim 18, further comprising sending a signal to the motor to drive the actuator for a predetermined time period preprogrammed into a memory of the controller and corresponding to a predetermined distance, the sending being performed by the controller.

20. The method of claim 18, further comprising wirelessly transmitting the input signal from a remote control to the controller, the remote control in wireless communication with the controller.
